(19) United States
(12) Patent Application Publication
(10) Pub. No.: US 2013/0042100 A1
(43) Pub. Date: Feb. 14, 2013

(54) METHOD AND APPARATUS FOR FORCED PLAYBACK IN HTTP STREAMING

(71) Applicants: Imed Bouazizi, Tampere (FI); Miska M. Hannuksela, Ruutana (FI)

(72) Inventors: Imed Bouazizi, Tampere (FI); Miska M. Hannuksela, Ruutana (FI)

(73) Assignee: NOKIA CORPORATION, Espoo (FI)

(21) Appl. No.: 13/206,415

(22) Filed: Aug. 9, 2011

(51) Int. Cl. H04L 29/06

(52) U.S. Cl. 713/151

(57) ABSTRACT

Systems and methods for enforcing playback of a specific portion of the content in an open non-certified media player/renderer are provided. In accordance with such systems and methods, a key is extracted from a content portion for which playback is to be forced. The extracted key allows a client the ability to gain access to additional/remaining content. Moreover, the existence of forced content, the mechanism(s) utilized for forcing playback, as well as a particular position in the timeline associated with the forced playback are signaled to the client on/through which the open non-certified media player/renderer is implemented.

### TECHNICAL FIELD

The present application relates generally to streaming data and, more particularly, to streaming via Hyper Text Transport Protocol (HTTP).

### BACKGROUND

HTTP Streaming has been developed as an alternative to Real-time Transport Protocol (RTP) based streaming, in order to circumvent some of the drawbacks of the latter method such as firewall and Network Address Translation (NAT) traversal, and distribution scalability. Recent activity in several standardization organizations have resulted in a standard for adaptive HTTP Streaming named Dynamic Adaptive Streaming over HTTP (DASH). The standard is open and allows for free development of the client player, thus only defining the formats for the data transmission and presentation description.

Content providers are increasingly offering their generated content free of charge via different video portals and social networks. At the same time, content providers are looking for alternative ways to monetize their content. The ad-sponsored distribution model has proven its efficiency and is thus offering a viable solution for monetizing on content distribution.

### SUMMARY

Various aspects of examples of the invention are set out in the claims.

According to a first aspect, a method comprises receiving, at a client apparatus, a presentation description file associated with selected media content; receiving one or more forced content segments associated with the selected media content, wherein at least one of the one or more forced content segments comprises a forced content key embedded therein; extracting the forced content key from the at least one forced content segment; and using the extracted forced content key, at least in part, to perform at least one of accessing the selected media content and rendering the selected media content.

According to a second aspect, a computer-readable memory includes computer executable instructions, the computer executable instructions, which when executed by a processor, cause an apparatus to receive, at the apparatus, a presentation description file associated with selected media content; receive one or more forced content segments associated with the selected media content, wherein at least one of the one or more forced content segments comprises a forced content key embedded therein; extract the forced content key from the at least one forced content segment; and use the extracted forced content key, at least in part, to perform at least one of accessing the selected media content and rendering the selected media content.

According to a third aspect, an apparatus comprises at least one processor and at least one memory. The at least one memory includes computer program code, the at least one memory and the computer program code configured to, with the at least one processor, cause the apparatus to perform at least the following: receive a presentation description file associated with selected media content; receive one or more forced content segments associated with the selected media content, wherein at least one of the one or more forced content segments comprises a forced content key embedded therein; extract the forced content key from the at least one forced content segment; and use the extracted forced content key, at least in part, to perform at least one of accessing the selected media content and rendering the selected media content.

According to a fourth aspect, an apparatus comprises means for receiving a presentation description file associated with selected media content; means for receiving one or more forced content segments associated with the selected media content, wherein at least one of the one or more forced content segments comprises a forced content key embedded therein; means for extracting the forced content key from the at least one forced content segment; and means for using the extracted forced content key, at least in part, to perform at least one of accessing the selected media content and rendering the selected media content.

According to a fifth aspect, a method comprises providing, by a server to at least one client apparatus, a media presentation description file associated with selected media content; providing, by the server to the at least one client apparatus, at least one of access to one or more forced content segments or information related to the one or more forced content segments, the forced content segments being associated with the selected media content; and providing, by the server to the at least one client apparatus, media segments of said selected media content, wherein playback of the forced content allows extraction of a forced content key by the at least one client apparatus, the forced content key being used, at least in part, by the at least one client apparatus to perform at least one of accessing the selected media content and rendering media segments of the selected media content.

According to a sixth aspect, a computer-readable memory includes computer executable instructions, the computer executable instructions, which when executed by a processor, cause an apparatus to provide, to at least one client apparatus, a media presentation description file associated with selected media content; provide, to the at least one client apparatus, at least one of access to one or more forced content segments or information related to the one or more forced content segments, the forced content segments being associated with the selected media content; and provide, to the at least one client apparatus, media segments of said selected media content, wherein playback of the forced content allows extraction of a forced content key by the at least one client apparatus, the forced content key being used, at least in part, by the at least one client apparatus to perform at least one of accessing the selected media content and rendering media segments of the selected media content.

According to a seventh aspect, an apparatus comprises at least one processor and at least one memory. The at least one memory includes computer program code, the at least one memory and the computer program code configured to, with the at least one processor, cause the apparatus to perform at least the following: provide, to at least one client apparatus, a media presentation description file associated with selected media content; provide, to the at least one client apparatus, at least one of access to one or more forced content segments or information related to forced content segments, said forced content segments being associated with the selected media content; and provide, to the at least one client apparatus, media segments of the selected media content, wherein playback of the forced content allows extraction of a forced content key by the at least one client apparatus, the forced content key being used, at least in part, by the at least one client apparatus to perform at least one of accessing the selected media content and rendering media segments of the selected media content.

According to an eighth aspect, an apparatus comprises means for providing, to at least one client apparatus, a media presentation description file associated with selected media content; means for providing, to the at least one client apparatus, at least one of access to one or more forced content segments or information related to the one or more forced content segments, the one or more forced content segments being associated with said selected media content; and providing, to the at least one client apparatus, media segments of said selected media content, wherein playback of the forced content segments allows extraction of a forced content key by the at least one client apparatus, the forced content key being used, at least in part, by the at least one client apparatus to perform at least one of accessing the selected media content and rendering media segments of the selected media content.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example system architecture for HTTP streaming and/or adaptive HTTP streaming;

FIG. 2 illustrates an example timeline for the playback of the forced content with respect to the playback of selected media content, according to an example embodiment;

FIG. 3a illustrates a first example embodiment of signaling information indicative of forced content to a receiving client device;

FIG. 3b illustrates a second example embodiment of signaling information indicative of forced content to a receiving client device;

FIG. 3c illustrates a third example embodiment of signaling information indicative of forced content to a receiving client device;

FIG. 3d illustrates a fourth example embodiment of signaling information indicative of forced content to a receiving client device;

FIG. 4a is a flow chart diagram illustrating a method for forced content playback performed by a client device, in accordance with various example embodiments;

FIG. 4b is a flow chart diagram illustrating a method, performed by a server, for providing media content associated with forced content playback in accordance with various embodiments of the present invention;

FIG. 5 illustrates an example embodiment for embedding a forced content key in metadata;

FIG. 6 illustrates an example embodiment for calculating a forced content key;

FIG. 7 illustrates an example mechanism for gaining access to the content of a media presentation based on forced content in accordance with an example embodiment;

FIG. 8 is an overview diagram of a system within which various embodiments may be implemented; and

FIG. 9 is a schematic representation of components of an example electronic device, which may be utilized in accordance with various embodiments.

FIG. 10 is a schematic representation of components of a server device which may be utilized in accordance with various embodiments.

### DETAILED DESCRIPTION OF THE DRAWINGS

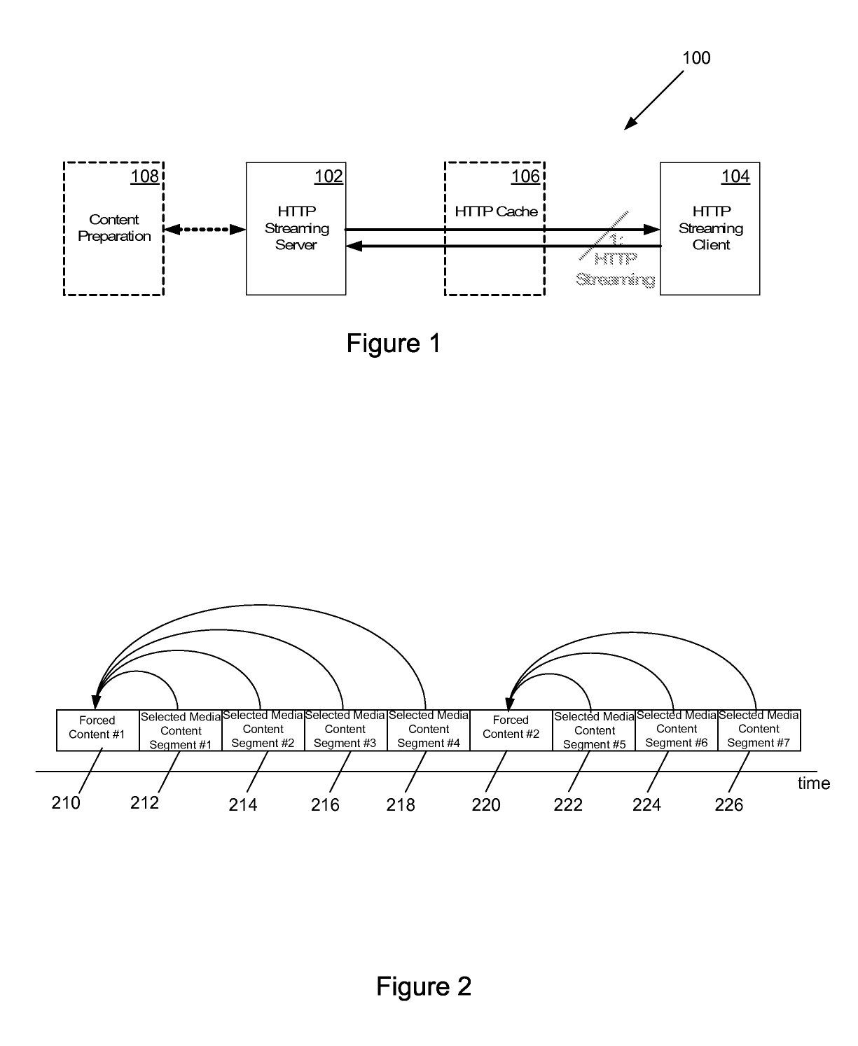

Example embodiments of the present invention and their potential advantages are understood by referring to FIGS. 1-10 of the drawings.

The transmission control protocol (TCP) has drawbacks when used for real-time delivery of media data. Recently, there is a shift towards the deployment of the Hyper Text Transport Protocol (HTTP) as a preferred protocol for the delivery of multimedia content over the Internet. HTTP runs on top of TCP and is a textual protocol. This shift may be attributable to the ease of deployment of HTTP. There is no need to deploy a dedicated server for delivering the content. Further, HTTP is typically granted access through firewalls and NATs, which significantly simplifies the deployment.

An Adaptive HTTP Streaming (AHS) solution has been standardized recently by the 3rd Generation Partnership Project (3GPP), and the same solution has been adopted by several other standardization bodies, such as Moving Picture Experts Group (MPEG) and Open IPTV Forum (OIPF).

Referring now to FIG. 1, an example of system architecture 100 associated with HTTP streaming and/or adaptive HTTP streaming is illustrated. In the system, an HTTP streaming server 102 provides content to one or more streaming client devices, such as HTTP streaming client device 104. The media content may be transmitted directly to the HTTP client devices from the HTTP streaming server 102. Alternatively, an intermediate web cache, or HTTP cache 106, may be used for temporarily storing media content. The streaming client 104 may be any of a variety of devices, such as a mobile handset, a laptop, a personal computer (PC), a tablet device, a set-up box, a personal digital assistant (PDA) device, a media player and/or the like.

In HTTP streaming and/or adaptive HTTP streaming, media content is prepared according to some format before delivery to client devices. The media content preparation may be performed by a separate entity, such as content preparation module, or content preparation server 108, by the HTTP streaming server 102, and/or by both entities together. Preparing the media content comprises segmenting the media content into one or more segments. An initialization segment is created to carry the information used to configure the media player to allow the streaming client device 104 to consume the media content.

The media content is typically encoded in one or more representations. Different representations of the media content correspond to, for example, different encoding bitrates, different languages associated with the media content, different compression formats, different resolutions for video content, and/or the like. The content representations may be alternatives to each other. For example, a user of the client device may select only one alternative out of the group of alternative representations. In other embodiments, the content representations may complement each other. The user may elect to add complementary representations that contain additional media components. For example, if audio and video content are encoded separately, the user may select an audio representation and a video representation to be played at the client device. In adaptive HTTP streaming (AHS), a client and/or the user, associated with the client device, may control rate adaptation by deciding which representation to consume at any particular time. A client comprises at least one of one or more software components and one or more hardware components, associated with a user device, for accessing and/or rendering media content.

The media content offered is usually described to the client using a media presentation description (MPD) file. The MPD file is, for example, an extensible markup language (XML) file that contains a description of the media content, periods of the media content, and the representations associated with the media content. A period represents a time interval of the media content. A period comprises one or more representations of the media content associated with the time interval. Each representation is, for example, an encoding of the media content with a different configuration. Representations may differ in various respects, such as bandwidth requirements, the media components they contain, the codecs in use, or languages, for example.

A representation, within a period, comprises one or more segments of the media content. Each representation includes information, which enables the streaming client to consume the media content. For example, a representation contains segment information. The segment information includes, for example, an initialization segment, and one or more media segments. Each media segment has a start time for the media of that particular segment and references a location for the corresponding media content.

In one embodiment, the MPD file is formatted according to the ISO-base file format and its derivates, e.g., the MP4 and the 3GPP file formats. The content is stored in so-called movie fragments. Each movie fragment contains the media data, e.g., media samples for the movie fragments residing in mdat boxes, and the corresponding metadata contained in moof boxes. The media data is typically a collection of media samples from all media components of the representation. Each media component is described as a track of the file.

In particular, a movie fragment feature enables splitting of the metadata that conventionally would reside in a moov box to multiple pieces, each corresponding to a certain period of time for a track. Thus, the movie fragment feature enables interleaving of file metadata and media data. Consequently, the size of the moov box can be limited. Metadata that can be included in the moof box is limited to a subset of the metadata that can be included in a moov box and is coded differently in some cases. Details of the boxes that can be included in a moof box can be found from the ISO base media file format specifications ISO/IEC International Standard 14496-12, Second Edition, 2005-04-01, including Amendments 1 and 2.

Advertisements are important to the sponsoring of content that is distributed free of charge. Specifically, advertisements provide a way for media content sponsors, and/or providers, to make a monetary revenue from the distribution of media content by forcing playback of advertisement content. However, with the emergence of open and client-based standards for media streaming such as HyperText Markup Language revision 5 (HTML5) and Dynamic Adaptive Streaming over HTTP (DASH), forcing the playout of a specific portion of content becomes more challenging. Simple instructions to a client are not sufficient as implementation of the client cannot be trusted. In other words, depending on the client implementation, a client device, with non-trusted client, may ignore such instructions and skip playing the advertisement content. For example, systems that utilize client based/controlled advertisement playout of downloaded content assume trust between a content provider and the client. As is the case with Digital Rights Management (DRM) trust management and services, the trust relationship between a content provider or server and a client requires certification of the client implementation. Such a system may not be preferred for DASH clients. According to an example embodiment of the present invention, a preferred forced content distribution system allows flexibility in the insertion of the forced content into media content, selected by a user, while enforcing the playback of the forced content.

In accordance with various embodiments, systems and methods for forcing playback of a specific content, e.g., advertisement content, in an open, e.g., non-certified, media player/renderer are disclosed. According to example embodiments of such systems and methods, a key is embedded in a code stream of the specific content for which playback is to be forced. For a client that is interested in consuming some selected media content, the access and/or rendering of the selected media content includes the use of the key embedded in the codestream of the specific content, e.g., forced content. As such, the client needs to extract the key in order to access and/or render the selected media content. Extracting the key includes decoding the codestream, at least partially, of the specific content.

FIG. 2 illustrates an example timeline for the playback of the forced content with respect to the playback of selected media content, according to an example embodiment of the present invention. According to the example in FIG. 2, the playback of the media content segments 212-218, of the selected media content is conditioned upon playback of the forced content segment 210. Specifically, a client device needs to play back the forced content segment 210 in order to extract the key, embedded in the codestream of forced content segment 210. The extracted key is then used to playback any of the media content segments 212-218. According to this approach, even if the user skips, for example, media content segment 212 and requests media content segment 214, the client device still needs to extract the key from the forced content segment 210. Similarly, the playback of the media content segments 222-226 is conditioned upon playback of the forced content segment 220. The approach described in FIG. 2 forces the playback of forced content segments even if the user of a client device decides to skip some media content segments and begin playback at a point other than the beginning of a media content.

In an alternative scenario, not all media content segments 212-218, but rather a subset of these segments would be conditioned, for playback, upon playback of the corresponding forced content segment, e.g., 210. Such subset may be selected randomly or according to some specified pattern. In an example pattern, the playback of every other media content segment is conditioned upon the playback of the corresponding forced content segment.

According to various example embodiments, at least one of an indication of the existence of forced content, associated with media content selected/requested by a client, information related to the extraction of the key embedded in the forced content and information related to the use of the extracted key to access the media content selected/requested by the client is/are signaled to the client device. For example, only the indication of the existence of the forced content may be signaled to the client device, whereas the mechanism for extracting the embedded key and the mechanism for using the key to access the media content may be known to the client device and as such are not signaled. In another example, the mechanism for extracting the key and/or the mechanism for using the key is/are signaled with the indication. In yet another example, signaled information associated with the key extraction and/or the way to use the key in order to access media content may be interpreted by the client device as an indication of the existence of forced content. Other information that may be signaled to the client device includes, for example, position(s) in the timeline associated with the forced content. According to an example embodiment, signaled information is sent to the client device in the MPD file. For example, when streaming a sports event or game, the MPD file may be updated based, at least in part, on the circumstances of the game and a change in the media content to be streamed, e.g., adding a particular targeted advertisement during a time-out in the game, following the game when the ending time of the game becomes known, and/or the like.

In another example embodiment, at least some of the information associated with the forced content, e.g., information related to key extraction mechanism and/or to information related to the mechanism for using the extracted key to access/render media content, may be signaled to the client device within the forced content codestream. In yet another embodiment, no signaling about the forced content is sent to the client device. For example, the client device may request a media content segment and gets re-directed, by the server, to a forced content segment. Further, the key extraction mechanism and the mechanism for using the key may be known to the client device, e.g., according to a standard, and as such no information is signaled the client device in this regard. It should be noted that the various embodiments may be implemented for a variety of different types of media, and changes to the media content and corresponding changes in the MPD file may be initiated based on other reasons and/or facts not necessarily limited to sports or games. Also, it is to be noted that forced content is not restricted, by any means, to advertisement content but may comprise public announcements, instructions to be sent to client users and/or the like.

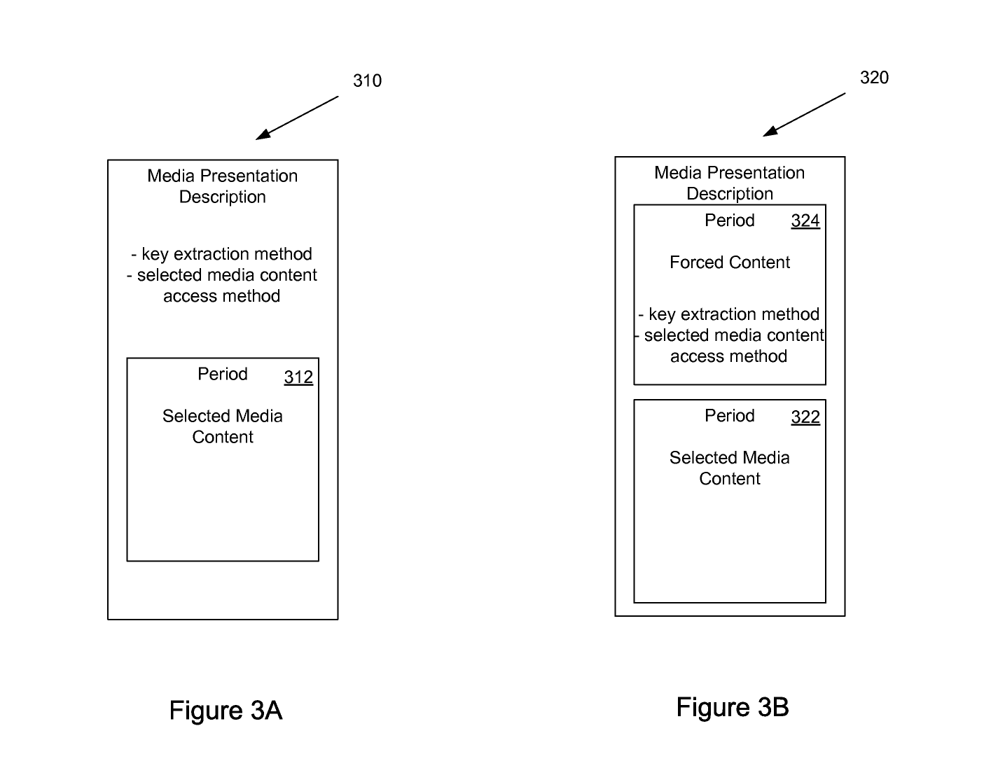

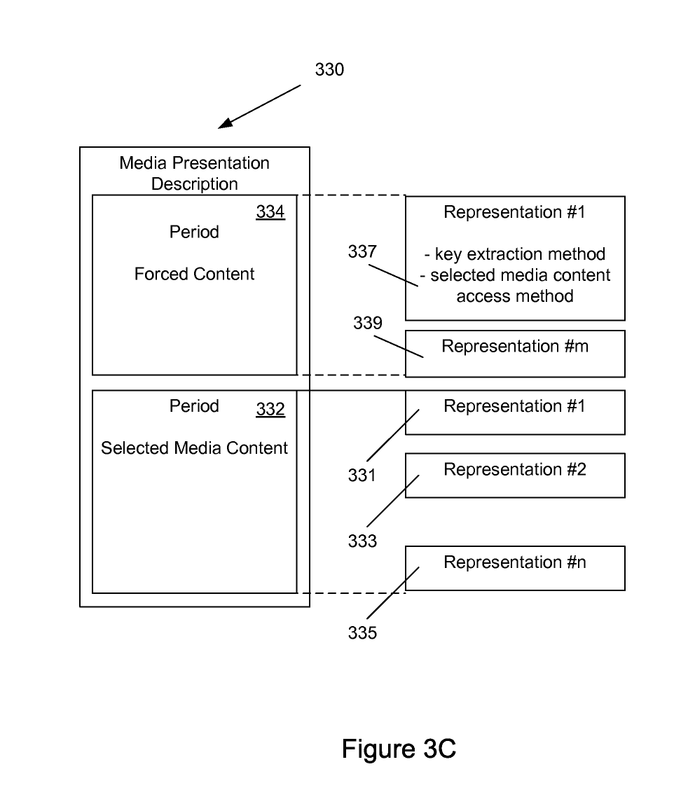

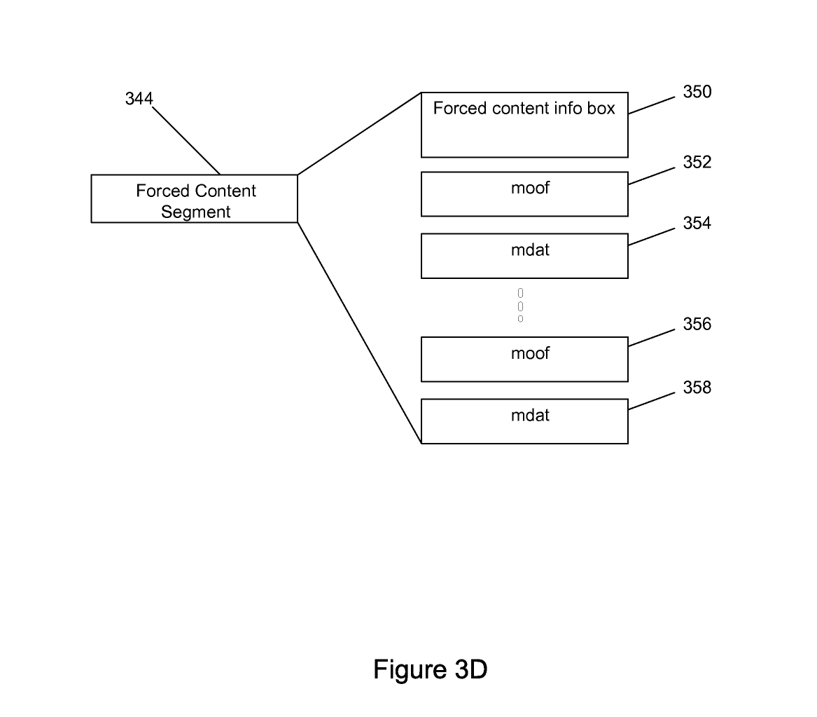

FIGS. 3a-3d illustrate examples of embedding signaled information in MPD files in accordance with various embodiments.

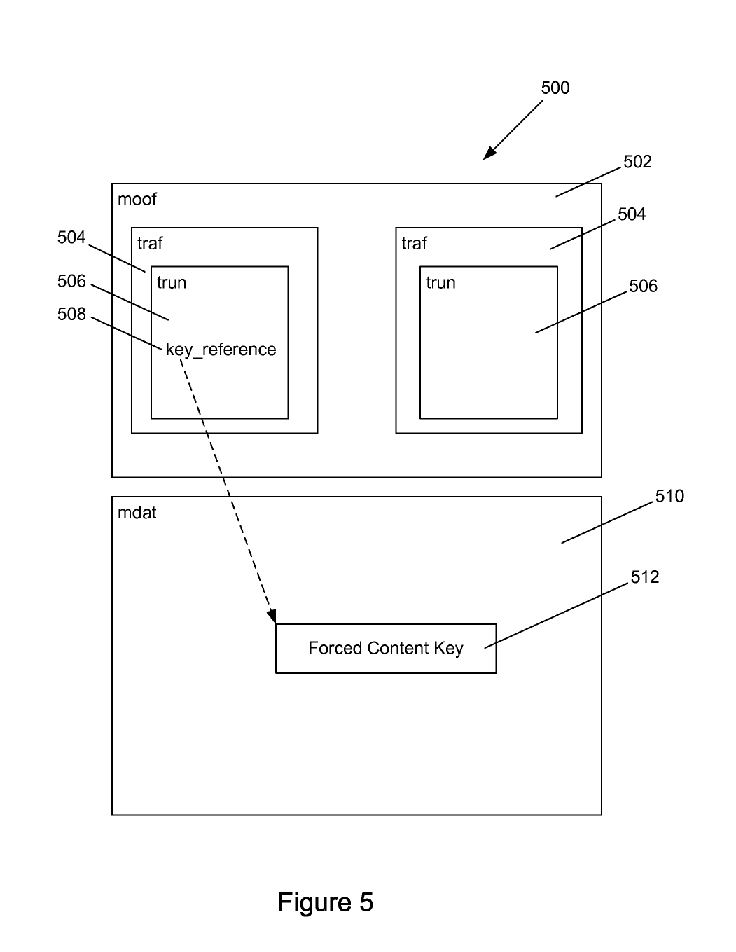

FIG. 3a illustrates a first example embodiment of signaling information, related to forced content, to a receiving client device. In the embodiment of FIG. 3a, the signaling is performed at the presentation level in the MPD file 310. In this regard, the information related to forced content comprises at least one of an indication of the existence of forced content, information related to the forced playback mechanism and information related to how to use the extracted key to access/render the media content. In the embodiment of FIG. 3a, the information related to forced content is outside the block 312 for the period of the media content. The use of the signaled information by the client device, e.g., key extraction method, selected media content access/rendering method, may be performed in a variety of manners, as described in greater detail below with reference to FIGS. 5-7, for example.

FIG. 3b illustrates a second example embodiment of signaling information related to forced content to a receiving client device. In particular, FIG. 3b illustrates an example MPD file 320 where information related to forced content is embedded at the period level. The MPD file is, for example, an extensible markup language (XML) file that contains, at least in part, a description of the content, periods of selected content, e.g., 322, and periods of forced content, e.g., 324. In accordance with the embodiment of FIG. 3b, the information related to the forced content is embedded, for example, in a period associated with forced content like period 324. The information related to the forced content comprises at least one of an indication that the forced content exists, key extraction information and media content access/rendering information. The key extraction information comprises information used by a client apparatus to extract a forced content key. The media content access/rendering information comprises information used by the client device to utilize the extracted key in accessing/rendering media content selected by the user.

FIG. 3c illustrates a third example embodiment of signaling information related to forced content to a receiving client device. FIG. 3c illustrates an example MPD file 330, where the information related to forced content is embedded at the representation level. The MPD file is, for example, an extensible markup language (XML) file that contains, at least in part, a description of the content, periods of media content, e.g., 332, and periods of forced content, e.g., 334. Additionally, FIG. 3c illustrates the content representations associated with the forced content period 334, e.g., representations 337 and 339, as well as the content representations associated with the media content period 332, e.g., representations 331, 333 and 335. According to the example embodiment of FIG. 3c, each of the representations associated with the forced content period 334, e.g., each of the representations 337 and 339, comprises signaling information indicative of forced content. The information related to the forced content comprises at least one of an indication that the forced content exists, key extraction information and media content access/rendering information. The key extraction information comprises information used by a client apparatus to extract a forced content key. The media content access/rendering information comprises information used by the client device to utilize the extracted key in accessing/rendering media content selected by the user.

FIG. 3d illustrates a fourth example embodiment of signaling information related to forced content to a receiving client device. According to the example embodiment of FIG. 3d, signaling information related to forced content is sent to a client device in a forced content media segment. In this regard, the forced content segment 344 includes a forced content information box 350, the media data, e.g., media samples for movie fragments which reside in mdat boxes such as 354 and 358, and the corresponding metadata which are contained in moof boxes, e.g., boxes 352 and 356. For example, the information related to the forced content may be embedded in the forced content info box 350 and the info box may be, for example defined as follows:

```
aligned(8) class ForcedContentInformation extends FullBox(‘fcif’,
version = 0, 0) {
      unsigned int(1) forced_content_flag;
      unsigned int(16) key_scheme_length;
      unsigned int(8) key_scheme_uri;
      unsigned int(8) content_access_method;
}.
```

In another example, the information related to the forced content may be embedded in one or more moof boxes, e.g., 352 and/or 356. The information related to the forced content comprises at least one of an indication that the forced content exists, key extraction information and media content access/rendering information. The key extraction information comprises information used by a client apparatus to extract a forced content key. The media content access/rendering information comprises information used by the client device to utilize the extracted key in accessing/rendering media content selected by the user.

The embodiment of FIG. 3d is advantageous in that the user or the client device may have no knowledge of the forced content. For example, the client device may request a segment using a link provided in the MPD file, without knowing that the requested segment is a forced content segment. Upon receiving the segment, the client device discovers that the segment is a forced content segment based on the signaled information within the segment. In another example, the client device requests a media segment. The server checks whether the request made by the client device includes a key, and if not the server redirects the client device to a forced content segment. Upon receiving the forced content segment, the client device may then read the signaled information, related to the forced content, embedded in the received forced content segment.

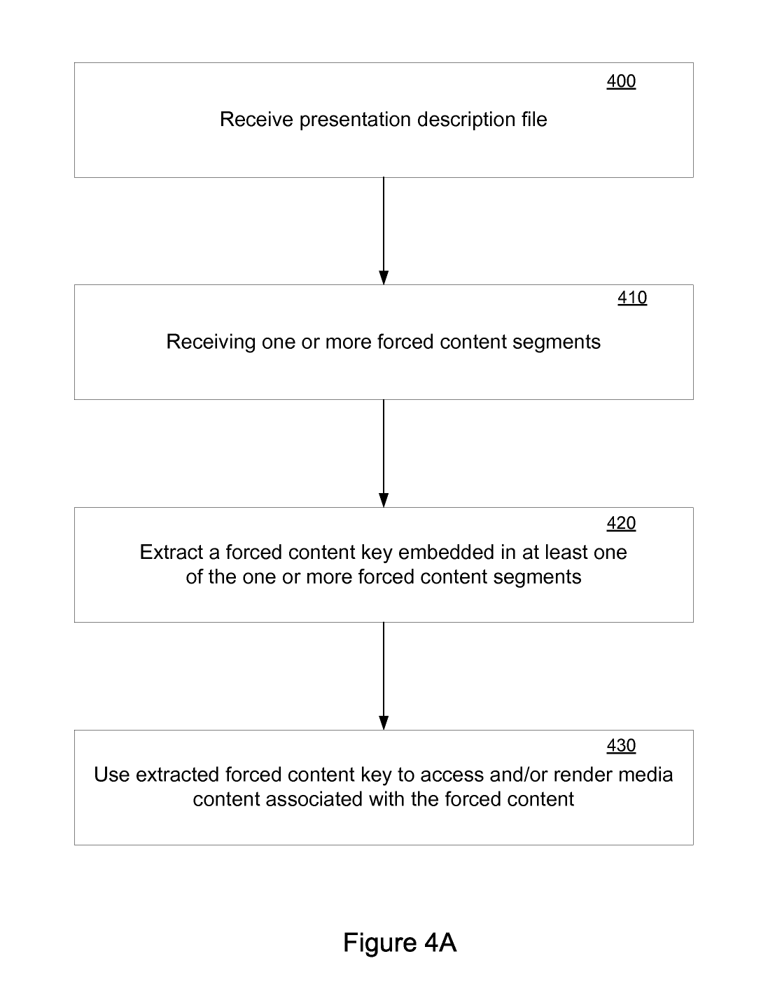

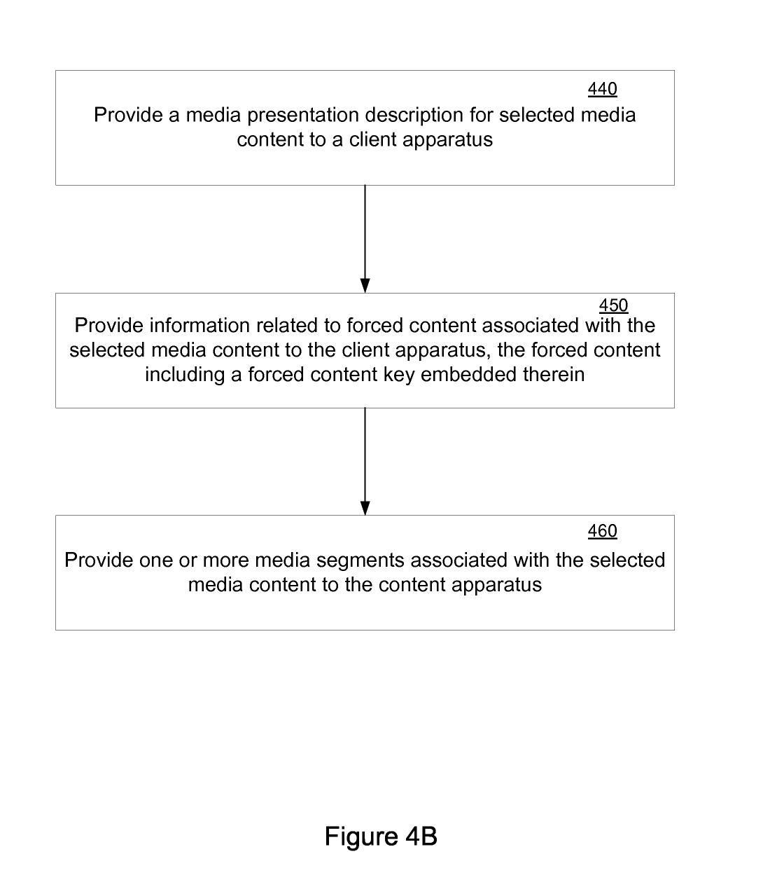

In other example embodiments, the signaled information related to forced content is distributed among one or more levels in the MPD file and/or within one or more forced content media segments. For example, the indication of existence of forced content, associated with requested media content, may be embedded within the MPD file at the presentation level and/or at the period level. In the same example, the key extraction information may be embedded at the representation level in the MPD file while the media content access/rendering information may be embedded within one or more forced content media segments. Alternatively, the media content access/rendering information may be embedded in the representation level with the key extraction information. It is to be noted that signaled information related to forced content may be sent to a client device within the MPD file, at one or more levels, and/or within forced content segments according to other arrangements. FIG. 4a is a flow chart diagram illustrating a method for access and playback of selected media content associated with forced content in accordance with various example embodiments. At 400, a presentation description file, such as the MPD file described above, is received at a client apparatus from a server. At 410, one or more forced content segments are received by the client apparatus. At 420, upon receiving the one or more forced content segments, a forced content key, embedded in at least one of the one or more forced content segments, is extracted by the client apparatus. At 430, the extracted forced content key is used to access and/or render the selected media content associated with the forced content.

The method of FIG. 4a may further comprise identifying indication of existence of forced content. The indication may be embedded, for example, in the presentation description file such as the MPD file. Alternatively, the client apparatus requests a selected media content segment and gets redirected by a server to a forced content segment, which includes information related to forced content. The information related to the forced content includes, for example, information about the location of the forced content key within the forced content segment and/or indication(s) on how to use the forced content key to access and/or render the requested media content. The information related to the forced content may further include an indication that the retrieved segment is a forced content segment given that the client device was re-directed to the forced content segment, by the server, without for example knowing priorly about the forced content segment.

In various embodiments, block 430 of FIG. 4a may be implemented in various manners. For example, in one embodiment, the server embeds the base URL or a part of the URL in the forced content as the forced content key. Partial URLs to the media segments of the selected content are provided, for example, in the media presentation description. The client extracts the forced content key from the forced content and combines it with the partial URLs to construct the complete media segment URLs and gain access to the media segments of the selected content.

In another embodiment, the server uses the forced content key in the encryption process of the URLs of the media segments corresponding to the selected content. The encryption process comprises, for example, using a symmetric key encryption algorithm such as Advanced Encryption Standard (AES). Client uses the extracted forced content key to decrypt the URLs and gain access to the selected content.

In still another embodiment, the client extracts the forced content key from the forced content and sends it as part of a request, for selected content segments, to an indicated server. The server checks and/or validates the key and upon positive validation returns a license, an encryption key and/or a rights object, of the corresponding selected content, to the client.

In still another embodiment, the client extracts the forced content key from the forced content and sends it as part of each request for a media segment from the selected content. The server checks the key received with/within the request and verifies, e.g. by comparing it with a copy of the forced content key stored in the server or by extracting the forced content key from forced content segments and performing the comparison. If the key is correct, the server delivers the requested segment. If not correct, the server redirects the client to the forced content or alternatively replies with the forced content instead. The server may, for example, re-direct the client apparatus to a forced content segment, including the forced content key, if the request had no key or if the key within the request is not positively validated by the server, e.g. not the right key. Alternatively, or additionally to the re-directing process, the server may provide the client apparatus with an error message.

FIG. 4b is a flow chart diagram illustrating a method, performed by a server, for providing media content associated with forced content playback in accordance with various embodiments. At 440, a server provides a media presentation description, e.g., MPD file, for media content selected by a client apparatus, to the client apparatus. At block 450, the server provides information related to forced content, associated with the selected media content, to the client apparatus. The forced content includes a forced content key embedded therein, wherein the forced content key is used by the client apparatus to access and/or render the selected media content. At block 460, the server provides one or more media segments, associated with the selected media content, to the client apparatus.

According to an example embodiment, the server provides the information related to the forced content within the media presentation description, e.g., MPD file. The information related to the forced content comprises at least one of indication of the existence of forced content, forced content access information, e.g., URL(s), information related to extraction of the forced content key from the forced content and information on how to use the extracted key to access/render selected media content. The information related to the forced content may be embedded at different levels within the media presentation description. Alternatively, the information related to the forced content may be, completely or partially, embedded within forced content segments. In yet another example, providing information related to forced content comprises receiving a request for a media content segment, of the selected media content, checking whether a key is included/sent with the request and, if not, re-directing the client apparatus to a forced content segment.

As described above, an embedded forced content key is extracted to give a client the ability to access and/or render selected media content. In accordance various embodiments, the forced content key is embedded as an imperceptible digital watermark in a media, e.g., video, file. The watermark may be hidden in different locations, where such locations depend on a watermarking key, which is used to generate a random sequence during the watermarking embedding process. Knowledge of the watermarking key is used to extract the watermark. The security of the watermark relies, at least in part, on the fact that it is hidden, imperceptible, directly connected to the media content, e.g., spread in/throughout a media file, statistically invisible, robust so that the watermark cannot be removed via compression or conversions, and tamper resistant.

For example, a differential energy watermark may be utilized for, e.g., intra coded frames, where high frequency discrete cosine transform (DCT) components from the data stream are selectively discarded. The method can be directly applied in the compression domain after identifying intra frames from the stream and then decoding the DCT coefficients. Bits for watermark data are embedded into each block by introducing an energy difference between top and bottom DCT coefficients of blocks. The value of an embedded bit is encoded as the sign of energy difference between two halves of the blocks. On the decoder side, the energy difference is calculated and the embedded bit is determined according to the sign off difference.

Alternatively, a video bitstream may be syntactically parsed, while data related to header information, motion, as well as texture are separated into different buffers. Header information and motion data are kept unchanged and added to an output bitstream. DCT data is computed by performing Huffman decoding and inverse quantization. Watermark data, which is to be embedded into the stream, is converted, e.g., using encryption, so that it is amenable for addition to the DCT data, and then added to the obtained DCT coefficients without increasing bit-rate. The altered DCT coefficients are then re-quantized and Huffman coded and then added to the bit-streams.

It should be noted that various methods of embedding watermarks may be utilized in order to also embed a forced content key. It should also be noted that when a forced content key is embedded as an imperceptible digital watermark, the forced content key can only be obtained after decoding the media content. The watermark must be obtained before any decoding operations that may tamper the watermark, e.g., it could be embedded as user data in the bitstream, or it may be applied on the compressed video stream as described above, thus avoiding uncompressed video watermarking techniques.

In accordance with another aspect of various embodiments, the forced content key may be embedded as part of the file format data, e.g. in the metadata. FIG. 5 illustrates an example of embedding a forced content key in the metadata of file format data, which shows a movie fragment 500 stored in the ISO base media file format. As described above, the requisite metadata may be included in moof boxes. For example, a moof box 502 may contain track fragment data in a traf box 504, and within the traf box 504, track run data which documents a contiguous set of samples for a track, contained in a trun box 506. Thus, in the case of ISO-base Media File Formats, a forced content key may be embedded in a new box or as part of an “mdat” box with correct referencing, i.e., a “key-reference” by the metadata boxes. The key reference may be encountered during processing of the metadata of a movie fragment which points to the forced content key within the media data stored in an mdat box.

Yet another aspect of various embodiments involves calculating a forced content key from the forced content or parts thereof, i.e., as a function of the received forced content. The forced content key could be calculated as a Message-Digest algorithm 5 (MD5) hash code, e.g., as defined in “The MD5 Message-Digest Algorithm” Request for Comments 1321, April 1992, for example, over the media data of all, or some designated, media segments from the forced content. Alternatively, the forced content key may be calculated over selected pictures or media samples from the content or over the full content of media segments.

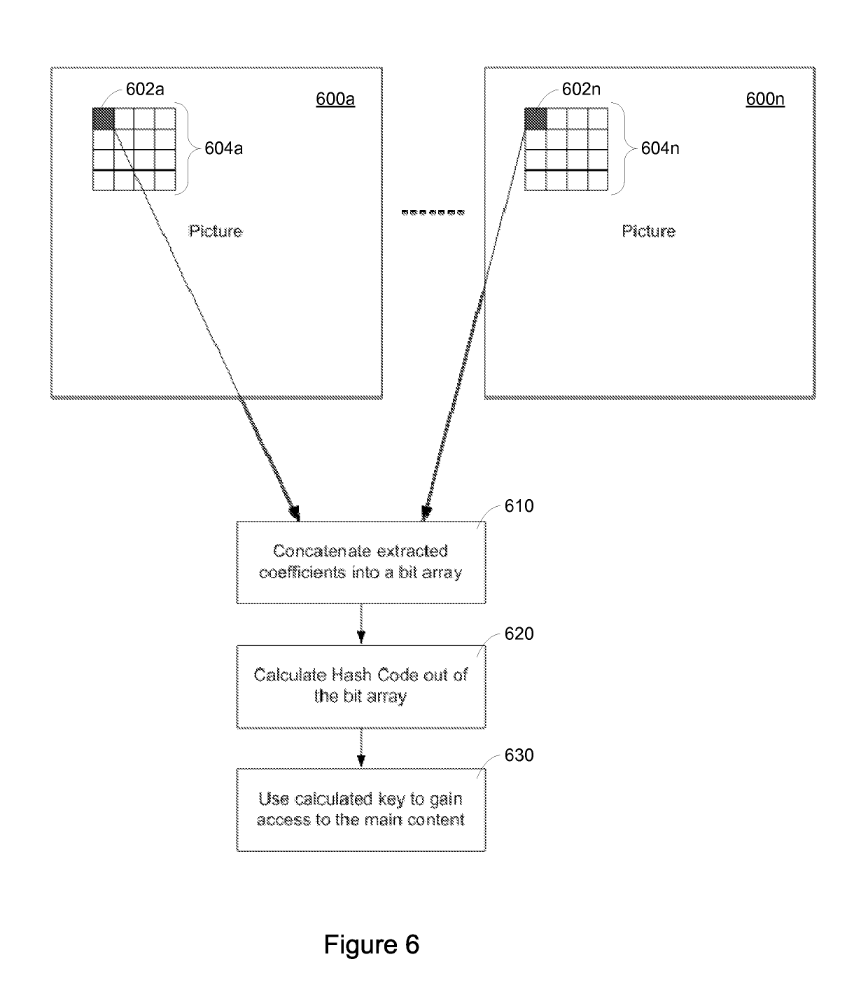

FIG. 6 illustrates a representational flow chart of processes performed for calculating a forced content key in accordance with one contemplated scenario. In this scenario, a client apparatus is instructed to extract the quantized DC coefficients 602a . . . 602n from each block/macroblock 604a . . . 604n of each picture or instantaneous decoding refresh (IDR) picture 600a . . . 600n. At 610, the extracted coefficients are concatenated to build a bit array. At 620, the bit array is hash coded, e.g., using the aforementioned MD5 hash coding. At 630, the calculated forced content key is used to gain access to the main/remaining/additional content. In accordance with this scenario, the client performs entropy decoding of the forced content.

In accordance with yet another scenario, the forced content key may be calculated over motion vectors from one of all the macroblocks or a subset thereof, the macroblocks or macroblock subset being from all or a designated subset of video pictures of the forced content. Alternatively still, the forced content key may be calculated over characteristics or data from an audio stream of the forced content. Such characteristics or data may, for example, refer to a selected set of quantized audio coefficients, or the characteristics/data may be from embedded error correction code coefficients.

In accordance with one embodiment, segment URLs may be obfuscated in order to force content playback. As indicated above, media content may be encoded in one or more representations. Each of these representations, in turn, consists of one or more segments, e.g., an initialization or media segment. Such segments are defined as units that can be referenced by an HTTP Uniform Resource Location (URL) included in the MPD, and may have assigned to them, an availability duration, for example. In this embodiment, the segment URLs are modified or encrypted using the forced content key. Hence, in order for a client to access the media segments, the client first restores the valid URL by using the forced content key. After detecting forced content from the MPD, the client determines the position of the forced content in the presentation timeline. It then initiates download and consumption of the forced content sufficiently in advance to allow for time to extract the content key. The extracted content key is then used to decode the segment URLs to the media segments that depend on the forced content piece. As indicated above, the client need not be a trusted client.

In accordance with another embodiment, encryption-based enforcement is utilized to protect content. In this regard, a forced content key may only be acquired after transmission and verification of the forced content key to a Rights Issuer. A client exchanges the forced content key that it has extracted from the forced content for the content key and uses the content key to decrypt the following content.

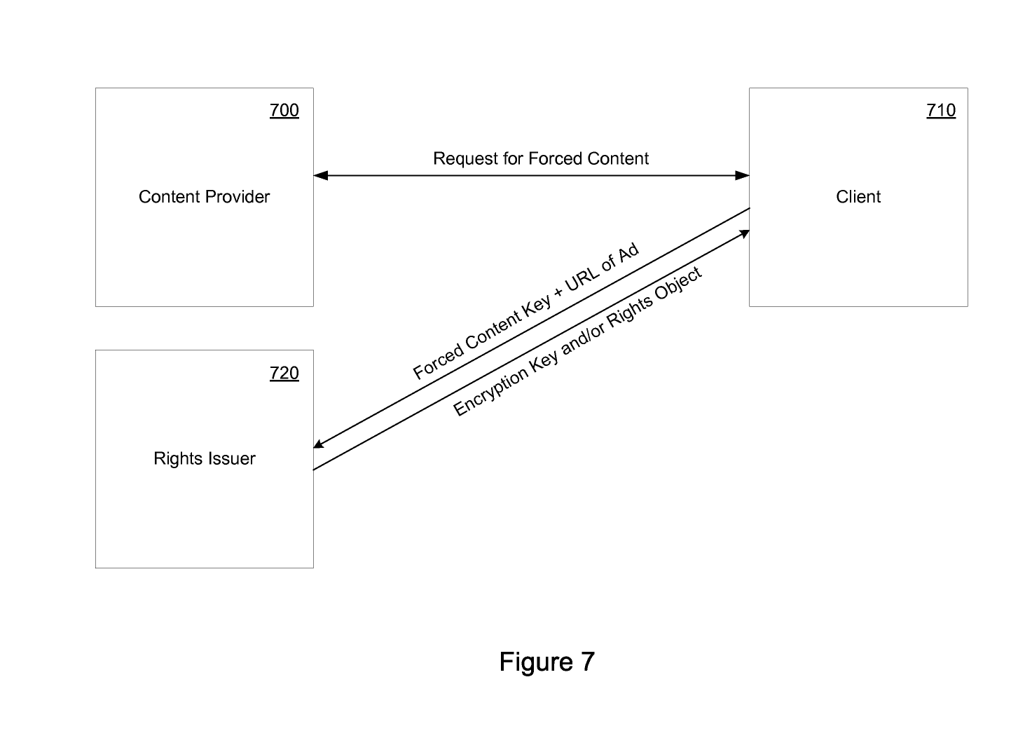

FIG. 7 illustrates an example procedure by which a client gains access to the content of a media presentation based on forced content. A content provider 700 provides media content to a client 710. The media content may contain forced content such as a forced playback advertisement, where the client 710 requests the forced content from the content provider 700. Upon receipt of the forced content at the client 710, an embedded forced content key is extracted from the forced content, or alternatively, the embedded forced content key is calculated as described above. Once the forced content key is extracted/calculated, the client transmits the forced content key in addition to the URL of the advertisement to a rights issuer 720. It should be noted that the rights issuer 720 may be separate from the content provider 700, or alternatively, may be the content provider 700 itself/part of the content provider 700. In exchange for receipt of the forced content key and the advertisement URL, the rights issuer 720 transmits the encryption key used to encrypt the media content desired by the client 710 and/or any rights object needed to consume the media content. The encryption key may then be utilized by the client 710 to decrypt the media content. Again, the client need not be a trusted client.

As indicated above, a client extracts/calculates a forced content key from/based upon received forced content. Hence, and in accordance with various embodiments, the existence of forced content is made known to the client through signaling, so that the client may locate it, time its playback, and extract the correct forced content key from it. In accordance with one embodiment, the forced content may be signaled as part of the MPD. The following table provides an example structure for the signaling and describes the different fields. It should be noted that other structures are possible and are contemplated by other embodiments. At least part of the signaled information, shown in the table below, may be embedded within the MPD file at different levels, for example, as described above with reference to FIGS. 3a-3c or may be embedded within the forced content, as described above with reference to FIG. 3d.

| | |
|---|---|
| @forced | Attribute indicating the existence of forced content. |
| @start | Attribute indicating the start of the forced content. If the |
| | client wishes to start playback at a time instant later than |
| | the start of the forced content, the client locates and plays |
| | the latest forced content preceding the desired time point. |
| @repetitions | Attribute indicating the number of repetitions that |
| | the forced content may be played. |
| @method | Attribute indicating the method to gain access to |
| | the content based on the forced content. |
| @usageReport | Contains the URL to a server to which reports as to the |
| | viewing/usage of the forced content are to be sent. |

Various embodiments allow for the enforcement of content consumption at the client as a feature of open HTTP Streaming solutions. The systems and methods disclosed herein operate on open standards for HTTP streaming without the need to trust and/or certify player implementations.

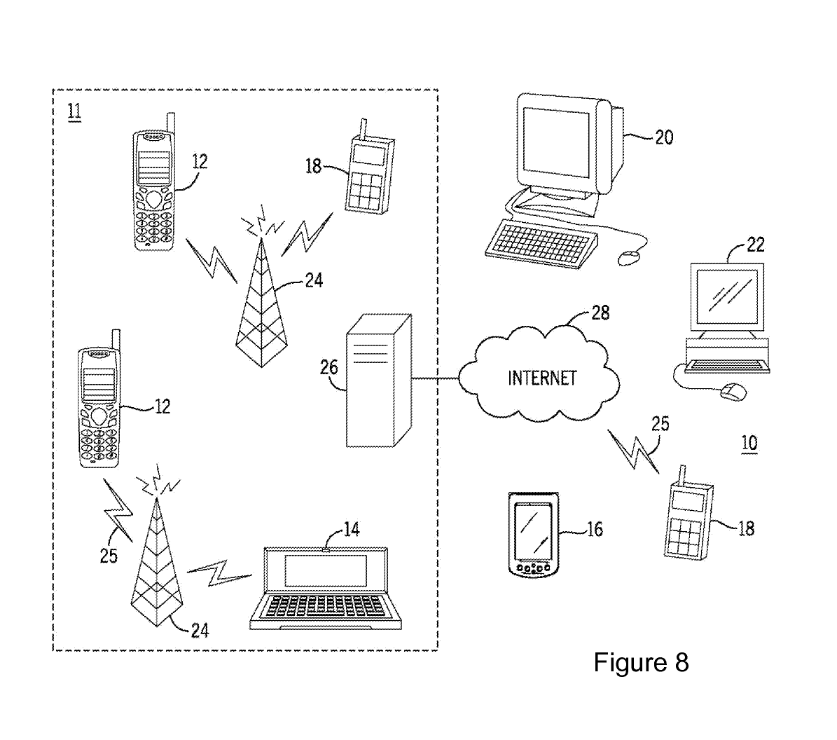

FIG. 8 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For example, the system 10 shown in FIG. 8 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The example communication devices, which may comprise client apparatuses, of the system 10 may include, but are not limited to, an electronic device 12, in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

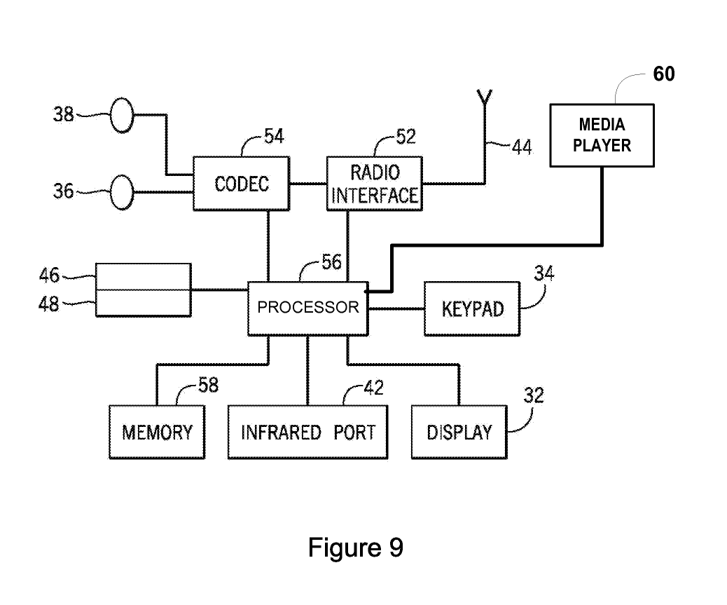

FIG. 9 shows one representative communication device, such as an electronic device which may be used in accordance to the various embodiments of the present invention. In embodiments of the present invention, the device of FIG. 8 may be representative of a client apparatus, a streaming server or a network device. It should be understood, however, that the scope of the present invention is not intended to be limited to one particular type of device. The electronic device of FIG. 9 may includes a housing, a display in the form of a liquid crystal display, a keypad 34, a microphone 36, an ear-piece 38, a battery, an infrared port 42, an antenna 44, a smart card 46 in the form of a UICC according to one embodiment, a card reader 48, radio interface circuitry 52, codec circuitry 54, one or more processors, such as processor 56, and one or more memories, such as memory 58.

Moreover, and in accordance with various embodiments, the device of FIG. 9, when representative of a client apparatus, may communicate with an HTTP server or a content provider server, from which content may be received for consumption/rendering/playout on a media player 60. The processor 56 may be configured to execute computer executable instructions which may be stored on one or more memory devices, such as memory device 58. Execution of the computer executable instructions by the processor 56 may cause the client apparatus to perform a method, such as the method described above with reference to FIG. 4a. The radio interface circuitry 52 allows the client apparatus to communicate with the aforementioned HTTP server, content provider server, and/or various other communication devices.

The above described components enable the electronic device to send/receive various messages to/from other devices that may reside on a network in accordance with the various embodiments of the present invention. Individual circuits and elements are all of a type well known in the art, for example in the Nokia range of mobile telephones.

Various embodiments described herein are described in the general context of method steps or processes, which may be implemented in one embodiment by a computer program product, embodied in a computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes. Various embodiments may comprise a computer-readable medium including computer executable instructions which, when executed by a processor, cause an apparatus to perform the methods and processes described herein.

Embodiments of the present invention may be implemented in software, hardware, application logic or a combination of software, hardware and application logic. The software, application logic and/or hardware may reside on a client device, a server or a network component. If desired, part of the software, application logic and/or hardware may reside on a client device, part of the software, application logic and/or hardware may reside on a server, and part of the software, application logic and/or hardware may reside on a network component. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 9. A computer-readable medium may comprise a computer-readable storage medium that may be any media or means that can contain or store the instructions for use by or in connection with an instruction execution system, apparatus, or device, such as a computer. In one embodiment, the computer-readable storage medium is a non-transitory storage medium.

If desired, the different functions discussed herein may be performed in a different order and/or concurrently with each other. Furthermore, if desired, one or more of the above-described functions may be optional or may be combined.

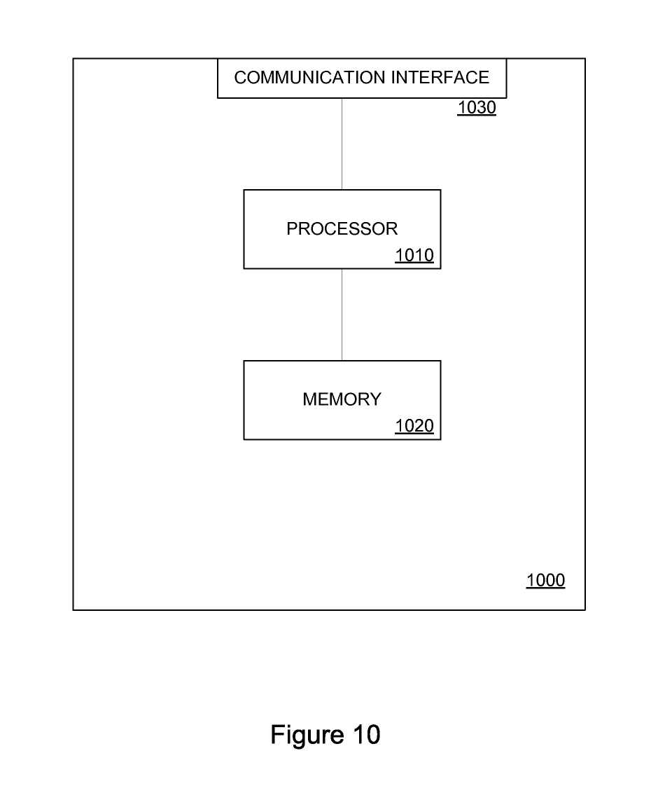

Referring now to FIG. 10, a server device according to one embodiment is schematically illustrated. The server device 1000 may be any of a variety of types of servers. In various embodiments, the server device 1000 is an HTTP server or a content provider server. The server device 1000 includes one or more processors, such as the processor 1010. The processor 1010 may be configured to execute computer executable instructions which may be stored on one or more memory devices, such as memory device 1020. Execution of the computer executable instructions by the processor 1010 may cause the server to perform a method, such as the method described above with reference to FIG. 4b. The server device 1000 further includes a communication interface 1030, allowing the server device 1000 to communicate with various other communication devices. For example, the server device 1000 may communicate with various client devices through, for example, a communication network

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
receiving, at a client apparatus, a presentation description file associated with selected media content;
receiving one or more forced content segments associated with said selected media content, wherein at least one of said one or more forced content segments comprises a forced content key embedded therein;
extracting the forced content key from said at least one forced content segment of the forced content; and
using the extracted forced content key, at least in part, to perform at least one of accessing the selected media content and rendering the selected media content.

2. The method of claim 1, further comprising receiving information related to the one or more forced content segments, said information comprises at least one of:
information embedded in the media presentation description file;
information embedded in the media presentation description file at a period level;
information embedded in the media presentation description file at a representation level;
information embedded in at least one of the forced content media segments;
information indicative of the existence of the one or more forced content segments;
information related to the embedded forced content key; and
information related to the use of the forced content key to perform at least one of accessing the selected media content and rendering the selected media content.

3. The method of claim 1, wherein receiving one or more forced content segments comprises:
requesting a selected media content segment; and
receiving a forced content segment if the request does not include the forced content key.

4. The method of claim 1, wherein extracting the forced content key comprises at least one of:
extracting the forced content key from an imperceptible digital watermark included in said at least one forced content segment;
calculating the forced content key from data decoded from codestream of said at least one forced content segment;
calculating the forced content key from data extracted from codestream of said at least one forced content segment; and
calculating the forced content key from at least a portion of the forced content as a hash code over media data comprising the forced content

5. The method of claim 4, wherein the imperceptible digital watermark comprises at least one of data embedded in an encoded bitstream containing the content and a digital watermark applied to a compressed video stream representative of the content.

6. The method of claim 1, wherein using the forced content key, at least in part, to perform at least one of accessing the selected media content and rendering the selected media content comprises at least one of: using the forced content key to construct a uniform resource locator associated with at least one selected media segment;
using the forced content key to decrypt a uniform resource locator associated with at least one selected media segment;
sending the forced content key to a rights issuer in exchange for an encryption key, said encryption key being for decrypting a uniform resource locator associated with at least one selected media segment or for decrypting selected media content; and
sending the forced content key in a request for selected media content segments.

7. The method of claim 1, wherein the presentation description file comprises a media presentation description (MPD) file formatted in an ISO-base media file format.

8. The method of claim 1, wherein the forced content key is referenced within metadata corresponding to media data.

9. The method of claim 6, further comprising receiving a rights object in conjunction with the encryption key in response to sending the forced content key to a rights issuer.

10. The method of claim 1, wherein the forced content comprises an advertisement required to be played to consume the content.

11. A computer-readable memory including computer executable instructions, the computer executable instructions, when executed by a processor, cause an apparatus to perform a method as claimed in claim 1.

12. An apparatus, comprising:
at least one processor; and
at least one memory including computer program code, the at least one memory and the computer program code configured to, with the at least one processor, cause the apparatus to perform at least the following:
receive, at a client apparatus, a presentation description file associated with selected media content;
receive one or more forced content segments associated with said selected media content, wherein at least one of said one or more forced content segments comprises a forced content key embedded therein;
extract the forced content key from said at least one forced content segment of the forced content; and
use the extracted forced content key, at least in part, to perform at least one of accessing or rendering the selected media content.

13. The apparatus of claim 12, wherein the at least one memory and the computer program code are configured to, with the at least one processor, further cause the apparatus to receive information related to the one or more forced content segments, said information comprises at least one of:
information embedded in the media presentation description file;
information embedded in the media presentation description file at a period level;
information embedded in the media presentation description file at a representation level;
information embedded in at least one of the forced content media segments;
information indicative of the existence of the one or more forced content segments;
information related to the embedded forced content key; and
information related to the use of the forced content key to perform at least one of accessing the selected media content and rendering the selected media content.

14. The apparatus of claim 12, wherein in receiving the one or more forced content segments the at least one memory and the computer program code are configured, with the at least one processor, to cause the apparatus to:
request a selected media content segment; and
receive a forced content segment if the request does not include the forced content key.

15. The apparatus of claim 12, wherein in extracting the forced content key the at least one memory and the computer program code are configured, with the at least one processor, to cause the apparatus to perform at least one of:
extract the forced content key from an imperceptible digital watermark included in said at least one forced content segment;
calculate the forced content key from data decoded from codestream of said at least one forced content segment;
calculate the forced content key from data extracted from codestream of said at least one forced content segment; and
calculate the forced content key from at least a portion of the forced content as a hash code over media data comprising the forced content

16. The apparatus of claim 12, wherein in using the forced content key, at least in part, to perform at least one of accessing the selected media content and rendering the selected media content, the at least one memory and the computer program code are configured, with the at least one processor, to cause the apparatus to perform at least one of:
use the forced content key to construct a uniform resource locator associated with at least one selected media segment;
use the forced content key to decrypt a uniform resource locator associated with at least one selected media segment;
send the forced content key to a rights issuer in exchange for an encryption key, said encryption key being for decrypting a uniform resource locator associated with at least one selected media segment or for decrypting selected media content; and
send the forced content key in a request for selected media content segments.

17. The apparatus of claim 12, comprises at least one of a mobile device, a wireless phone, a digital tablet, a personal digital assistant, a laptop, a personal computer and a smart phone.

18. A method, comprising:
providing, by a server to at least one client apparatus, a media presentation description file associated with selected media content;
providing, by the server to said at least one client apparatus, at least one of access to one or more forced content segments and information related to forced content segments, said forced content segments being associated with said selected media content; and
providing, by the server to said at least one client apparatus, media segments of said selected media content,
wherein playback of the forced content allows extraction of a forced content key by the at least one client apparatus, the forced content key being used, at least in part, by the at least one client apparatus to perform at least one of accessing or rendering media segments of the selected media content.

19. The method of claim 18, wherein provided information related to forced content segments comprise at least one of:
information embedded in the media presentation description file;
information embedded in the media presentation description file at a period level;
information embedded in the media presentation description file at a representation level;
information embedded in at least one of the forced content media segments;
information indicative of the existence of the one or more forced content segments;
information related to the embedded forced content key; and
information related to the use of the forced content key to perform at least one of accessing the selected media content and rendering the selected media content.

20. The method of claim 18, wherein providing access to one or more forced content segments comprises:
receiving a request for a selected media content segment; and
redirecting the client apparatus to a forced content segment if the request does not include the forced content key.

21. The method of claim 18, wherein providing media segments of said selected media content comprises determining whether a request for a selected media content segment comprises the forced content key and if the forced content key is received with or within the request providing the selected media content segment to the client device;

22. A computer-readable memory including computer executable instructions, the computer executable instructions, when executed by a processor, cause an apparatus to perform a method as claimed in claim 18.

23. An apparatus, comprising:
at least one processor; and
at least one memory including computer program code, the at least one memory and the computer program code configured to, with the at least one processor, cause the apparatus to perform at least the following:
provide, to at least one client apparatus, a media presentation description file associated with selected media content;
provide, to said at least one client apparatus, at least one of access to one or more forced content segments and information related to forced content segments, said forced content segments being associated with said selected media content; and
provide, to said at least one client apparatus, media segments of said selected media content,
wherein playback of the forced content allows extraction of a forced content key by the at least one client apparatus, the forced content key being used, at least in part, by the at least one client apparatus to perform at least one of accessing and rendering media segments of the selected media content.

24. The apparatus of claim 23, wherein provided information related to forced content segments comprise at least one of:
information embedded in the media presentation description file;
information embedded in the media presentation description file at a period level;
information embedded in the media presentation description file at a representation level;
information embedded in at least one of the forced content media segments;
information indicative of the existence of the one or more forced content segments;
information related to the embedded forced content key; and
information related to the use of the forced content key to perform at least one of accessing the selected media content and rendering the selected media content.

25. The apparatus of claim 23, wherein in providing access to one or more forced content segments, the at least one memory and the computer program code are configured to, with the at least one processor, cause the apparatus to perform at least the following:
receive a request for a selected media content segment; and
redirect the client apparatus to a forced content segment if the request does not include the forced content key.

26. The apparatus of claim 23, wherein in providing media segments of said selected media content, the at least one memory and the computer program code are configured to, with the at least one processor, cause the apparatus to determine whether a request for a selected media content segment comprises the forced content key and if the forced content key is received with or within the request provide the selected media content segment to the client device.
